(19) United States
(12) Patent Application Publication
(10) Pub. No.: US 2022/0113691 A1
(43) Pub. Date: Apr. 14, 2022

(54) COMPUTER PROGRAM PRODUCT FOR READING STATUS DATA OF ELECTRICAL POWER UNITS, METHOD FOR PROVIDING CONTROL POWER AND/OR FOR OPTIMIZING OWN CONSUMPTION AND ELECTRICAL ENERGY STORE

(71) Applicant: Sonnen GmbH, Wildpoldsried (DE)

(72) Inventor: Tim KIMPEL, Kempten (DE)

(73) Assignee: Sonnen GmbH, Wildpoldsried (DE)

(21) Appl. No.: 17/423,577

(22) PCT Filed: Jan. 15, 2020
(86) PCT No.: PCT/DE2020/100022

§ 371 Date: Jul. 16, 2021

(30) Foreign Application Priority Data
Jan. 16, 2019 (DE) 10 2019 101 082.9

(51) Int. Cl. G05B 19/042; G06F 3/0482; G06V 10/94

(52) U.S. Cl. CPC G05B 19/042; H04L 67/125; G06V 10/945; G06F 3/0482

(57) ABSTRACT

A non-transitory computer readable medium storing computer code which, when executed by a computer, causes the computer to access and activate software applications of accredited electrical power units by using personal access data that are used for automated access to the software applications of the accredited electrical power units and are held for this purpose in access data storage, and to perform image capture and image evaluation of graphical representations that are available, having been generated by the software applications, during the automated access to the software applications of the accredited electrical power units. The image evaluation ascertains status data of the accredited electrical power units and stores the status data in a status data memory and/or transmits the status data to a controller.

The invention relates to a computer program product for reading status data of a plurality of electrical power units connected to an electrical energy network in a technical unit, wherein each of these electrical power units has an assigned software application and the software applications of these electrical power units are installed or installable on a digital terminal or on a plurality of digital terminals. These software applications are normally provided for the end user by the manufacturers of the electrical power units. They can be typical “apps” for personal digital assistants such as smartphones and tablets or else smart home programs for desktop and laptop computers. It is likewise conceivable for the assigned software application not to function as standalone software and therefore not to generate its own graphical representation, but rather to be integrated in a comprehensively acting smart home program that is in the form of an app for smartphones and tablets or in the form of a smart home program for desktop and laptop computers.

In the technical field of transmission network operators, technical units normally have a power potential that is such that they can draw or deliver negative and/or positive control power in the form of primary control power or secondary control power in the MW range. For the purposes of the present invention, the technical unit is defined to be very much smaller. That is to say that a technical unit for the purposes of the invention is in the form of a single building already, for example. To be more precise, the technical unit is defined as the sum of all electrical energy consumers and/or electrical energy generators whose electrical power flows between the technical unit and the transmission network are recordable by way of a common electrical meter unit.

For the purposes of the present invention, the various electrical energy consumers and electrical energy generators are referred to generically as electrical power units. They are made up of a mixture of power drawing units, power delivering units and power drawing/delivering units selected from the group comprising:
electrical loads, (exclusively for electrical power draw)
electrical stores (both for electrical power draw and for electrical power delivery) and
electrical generators (exclusively for electrical power delivery).

It is assumed that inside the technical unit there is provision for an electrical power unit that can draw electrical power and, by functioning as a store, deliver it again in a delayed manner. Such an electrical power unit is for example an electrical energy store that stores the electrical energy by means of secondary cells or capacitors. However, electrical energy stores are likewise conceivable in which an energy conversion is performed from electrical to mechanical or thermal energy, which allows the reversible conversion of mechanical or thermal energy back to electrical energy, deducting certain losses.

Inside technical units such as these, for example in the form of the building or a building complex of a household or a commercial operation, there are numerous electrical power units that can operate so as to optimize their own consumption and/or to support the network by means of specific switching and/or control.

Optimized for their own consumption means that the electrical power demands of the electrical power units connected to the power supply network of the technical unit are controlled such that the amount of electrical energy that has been generated by means of an energy-generating electrical power unit (e.g. a PV installation, wind or hydroelectric power installation) of the technical unit is consumed to the greatest possible extent by the electrical-power-drawing electrical power units of the same technical unit. This can be accomplished either by direct use of the electrical power generated by means of the energy-generating electrical power unit or by use of the electrical energy buffer-stored in an electrical energy store. Specific and flexible actuation of the power units of a technical unit as per the definition of the present invention on the basis of the state of charge of the electrical energy store, the weather forecasts and the electrical consumption forecasts therefore pursues the aim of the own consumption rate of the technical unit, which is in the form of a household in a single-family house or in the form of a commercial operation, for example. So-called smart home systems have been developed for this purpose in particular, these involving a multiplicity of the electrical power units inside the technical unit of a smart home being able to be networked to one another and being able to be controlled by means of a smart home program that can be operated on digital terminals.

Operating the electrical power units to support the network, in this context, means that the controlled electrical power units of a technical unit match the electrical power that needs to be obtained or to be delivered to the requirements of the local and supra-regional transmission network depending on the state of the transmission network. As such, in simple terms, it is important for safe and stable operation of a transmission network that the sum of the network infeeds (electrical energy generation supplied per time interval) at any time corresponds to the sum of the network withdrawals (electrical energy obtained by all electrical power units acting as consumers per time interval), since only this equilibrium results in both the distribution networks and the transmission networks operating at the stable frequency of 50 Hz and hence in the safe and stable state. The network infeed is defined by the sum of the power stations connected to the networks and is not arbitrarily variable in short time intervals, for example in the order of magnitude of between a few and many minutes. To compensate for the lack of variability of the supply of power, the aforementioned equilibrium can be maintained by altering the electrical power consumption, however. The electrical power consumption is directly related to the actuation of those electrical power units of the technical unit that are suitable for drawing electrical power. The electrical power draw of electrical power units can therefore take place to support the network, in order to stabilize the transmission networks.

The basis for controlling the power units in a technical unit so as to optimize their own consumption and/or to stabilize the network is not only knowledge of the present requirements of the transmission network, however, but also knowledge of the state, to be more precise the potential to draw or deliver electrical power, of the electrical power units. By way of example, the state of charge of an electric vehicle or the present temperature of a freezer are crucial for the potential that is to be found at any time for these electrical power units to be able to be controlled so as to support the network and/or to optimize their own consumption. The status of the electrical power units inside a technical unit as per the definition of the present invention can normally be discovered only by people who are physically situated in the technical unit and can therefore physically access the electrical power units, or people in possession of administrative access rights can ascertain the status data of some electrical power units via a smart home system and/or via specific software applications (apps) of the electrical power units on their digital terminals.

Many of the smart home systems currently on the market often have the problem that they are in a proprietary form such that cross-manufacturer integration of a wide variety of electrical power units is not supported by the associated smart home programs on the digital terminals or is possible only with a high level of programming complexity. Only few electrical power units have an open interface themselves that can be used to query status data of the associated electrical power unit universally, i.e. without using proprietary standards. A great many electrical power units have an associated software application, however, that can be installed on digital terminals as dedicated software or can be integrated into an existing smart home program. The administrator users of these digital terminals can operate and control the electrical power units by using the associated software application or the smart home programs with the electrical power units integrated therein by way of the software application. However, these software applications and smart home programs again lack an interface that permits the reading of status data for controlling the associated electrical power units so as to support the network and/or to optimize their own consumption.

The present invention is therefore based on the object of providing a computer program product that easily allows status data of as many electrical power units of a technical unit as possible to be ascertained without this requiring the electrical power units or the software applications thereof to be modified.

This object is achieved by a computer program product having the features of claim 1 and by a method using such a computer program product having the features of claim 11.

According to the invention, there is provision for the computer program product to have software means that, when executed on a computer, cause the computer to perform the following steps:
access to and activation of software applications of accredited electrical power units by using personal access data that are required for automated access to the software applications of accredited electrical power units by the computer program product and are held for this purpose in access data storage means of the computer program product, and
image capture and image evaluation of graphical representations that are available, having been generated by the software applications, during the automated access to the software applications of the accredited electrical power units, wherein the image evaluation is designed to ascertain status data of the accredited electrical power units and to store said status data in a status data memory and/or to transmit said status data to a control unit.

Accreditable electrical power units are devices of the technical unit that each have a software application that, in a previously known manner, visualize status data of the accredited electrical power unit in the form of graphical representations, which are generated by the associated software application.

This graphical representation can visualize the status data of the electrical power unit in particular as numerical parameters and/or in the form of a graph. As the style of the visualization is known beforehand, the image capture and image evaluation are simplified.

An administrator user of the electrical power units of the technical unit must previously have selected electrical power units that actually need to be accredited from the subset of the accreditable electrical power units. The personal access data required for automated access to the software applications of accredited electrical power units by the computer program product need to be handed over or approved by the administrator user, and said data are then stored in access data storage means of the computer program product.

This administrator user dialog required for the computer program product to work can be carried out by another computer program product. Prior to the administrator user dialog, this other computer program product would then identify electrical power units accreditable by the computer program product from the total number of electrical power units present in the technical unit.

It is likewise conceivable for the steps of the administrator user dialog and of the preceding identification of accreditable electrical power units to be carried out by the computer program product itself, or for just one of these two steps to be carried out by the computer program product and for the other to be carried out by the other computer program product. This will be described in even more detail on the basis of the preferred embodiments outlined below.

It is crucial that the administrator user of the electrical power units makes a selection that leads to a selected plurality of accredited electrical power units inside the technical unit. For each of the accredited electrical power units, the personal access data permitting the computer program product to access the assigned software application of the accredited electrical power unit are stored in the access data storage means.

The computer program product permits the status data of a plurality of electrical power units accredited in this way to be ascertained without the need for all accredited electrical power units to be designed with suitable interfaces for handing over these status data. It is merely necessary for all accredited electrical power units to possess assigned software applications and for these software applications, after they are activated, to visualize the desired status data in the form of graphical representations. The manner of visualization is known on the basis of the respective version number of the accredited software application, which simplifies the image capture and image evaluation.

The software applications are usually also covered by the purchase price of an electrical power unit. Normally, the electrical power unit is accompanied by an indication of where the associated software application can be downloaded at no cost. The automated use of these software applications by means of the personal access data of an administrator user requires no individual adaptation of the computer program product, which keeps the complexity for ascertaining the relevant status data very low. It is merely necessary to analyze where and how the status data are visualized in the software application so that these areas can be analyzed in a targeted manner by the image capture and image evaluation. Last but not least, such a described “second use” of the software application, which merely simulates a real administrator user with the express consent thereof, has no associated licence costs whatsoever with regard to the manufacturer of the accreditable electrical power unit along with the associated software application. Additionally, this allows costs to be avoided that often arise when the manufacturer of an electrical power unit having an open interface requests information via this open interface.

The steps of the access to the accredited software applications and the subsequent image capture and image evaluation are periodically repeated at a suitable frequency or the ascertainment of the status data is triggered by an external request. Ultimately, either the status data reach a control unit directly without prior storage in a status memory or said status data are initially stored in the status memory, which is later read when required so that the status data are then transmitted to the control unit.

The control unit is the device that supervises control of the electrical energy flows in the technical unit in a manner optimized for own consumption and/or to support the network. This device can be situated inside the technical unit or else can be arranged outside it. If the control unit is situated inside the technical unit, said technical unit will also interact with other control units situated outside the technical unit. This applies particularly if the control unit is supposed to realize an electrical energy flow to and from the accredited electrical power units that supports the network.

Character and pattern recognition methods known from the prior art are used for the image evaluation of the graphical representations of accredited software applications.

Preferably, the computer program product is designed such that during the access to and during the activation of accredited electrical power units a database of the computer program product or a database access function provides information that simplifies localization and/or the image evaluation of relevant areas in the graphical representations of the software applications of accredited power units for the purpose of ascertaining the status data. As it is known which program version of the respective accredited software application is used, the relevant areas of the graphical representations for the image capture and image evaluation can be analyzed in advance. Information about the positioning and various graphical representation scenarios on the basis of the real status data or administrator-user-specific settings on the accredited software application is stored in the database as part of the computer program product or in an external database that the computer program product accesses.

Additionally, it is advantageous that the ascertained status data are converted into a standard numerical code and stored. This simplifies the further processing by the control unit performing control of the energy flows that is optimized for own consumption and/or supports the network. The conversion and storage are preferably carried out by the computer program product and in the status data memory of the computer program product itself. As such, it is possible for example for the accredited software application of automotive manufacturer A to indicate the state of charge of the electric automobile as a percentage, while automotive manufacturer B visualizes the identical information in the unit kilowatt-hours. During an exemplary charging process, the battery of automotive manufacturer A has therefore already reached 80% of the battery capacity according to the accredited software application, while the accredited software application of automotive manufacturer B provides the information that 80 kWh of a total of 100 kWh battery capacity have already been charged. In both cases, the computer program product conveys the standard information that the batteries can still draw energy amounting to 20 kWh.

A particularly preferred embodiment of the computer program product is distinguished in that the access data storage means are designed to be protected against being read by networked devices that are situated outside the network domain in which the computer program product is installed. This establishes a certain first security hurdle so that the personal access data of an administrator user for the accredited software applications do not leave the network domain.

Additionally or alternatively, the computer program product is advantageously distinguished in that the access data storage means are designed to be protected against being read by networked devices with a different IP address than the IP address of the computer on which the computer program product is installed. Reading of the access data storage means therefore imperatively requires the accredited software applications and the computer program product to be installed on the same computer. This computer can be a digital terminal of the administrator user of the technical unit in the form of a smartphone or a tablet. Similarly, however, it is conceivable for it to be the computer of an electrical power unit in the form of an electrical energy store or the computer of an electrical power unit in the form of a charging station together with the battery of an electric vehicle connected to the charging station. Additionally, it can also be a computing unit that, without design reference to another functional unit, for example in the form of an electrical energy store or a charging station, is integrated in a technical unit so as merely to serve the purpose of providing an operating system for the computer program product and the accredited software applications.

It is advantageous for all of the previously described variants of the computer program product that the ascertained status data also comprise performance parameters of the accredited electrical power units. The term performance parameters covers settings made by the administrator user that depend on the administrator user's requirements. By way of example, that the electric vehicle connected to the charging station in the evening will not be used again until 8 o'clock the next morning and for example would be acceptable even with a 50% battery charge. Additionally, performance parameters cover recurring routines. By way of example, a lawnmower robot is supposed to mow the lawn every Wednesday if possible, a robot vacuum cleaner in the house is always supposed to become active on Friday mornings, and the heat pump is supposed to be active or passive at a desired time, depending on planned patterns of presence of the administrator user or of his relatives and colleagues who might be inside the technical unit. The capture of such performance parameters, if they can be stored by means of the accredited software applications, permits an even more finely granulated assessment, on the timeline, of the probability of the electrical energy flows of the accredited electrical power units that are required for optimizing their own consumption or to allow the network to be supported.

As already mentioned, a particularly advantageous embodiment of the computer program product provides for the following steps to also be carried out before the steps of the access to and the activation of software applications of accredited electrical power units and before the steps of the image capture and the image evaluation:
menu-driven and administrator-user-controlled identification of electrical power units from a total number of electrical power units in the technical unit that are accreditable by the computer program product, that uses a database or a database access function to identify the associated software applications of the accreditable electrical power units, and
initiation of an administrator user dialog that an administrator user uses to select those of the electrical power units detected as accreditable that are supposed to be accredited by the computer program product, wherein the personal access data for the software applications of the electrical power units to be accredited are captured and stored.

The entire chain of functionality of the steps of identification of accreditable electrical power units, accreditation and evaluation of the software applications of accredited electrical power units is therefore combined in the computer program product. The administrator user controls the process in this case by using menu guidance to select the generic terms of the electrical power units, such as for example refrigerator or freezer, from his technical unit that he wishes to have accredited. The menu guidance is aided in this by the database of the computer program product or the database access function. After identifying his specific electrical power unit, the administrator user receives an acknowledgement of whether or not accreditation of this electrical power unit is possible. Preferably, the ascertained status data are also stored in the computer program product and can be read by an external control unit for the purpose of optimizing own consumption and/or controlling energy flow for the technical unit so as to support the network.

In one preferred development, during the capture of the personal access data the administrator user is provided with a selection option for his personal access data to be stored exclusively in the computer program product, which is installed on a computer that is integrated inside the technical unit or is in the form of a digital terminal of the administrator user, wherein the computer is set up such that external access for the purpose of reading these personal access data from the computer program product is blocked without exception. In this way it is possible to ensure a high degree of security that the personal access data do not get into the wrong hands as a result of centrally organized data theft on a large scale. This can increase the acceptance of storage of personal access data by the administrator users.

For the previously described embodiment of the computer program product with the entire chain of functionality, one advantageous development is characterized in that after the steps of the menu-driven and administrator-user-controlled identification of accreditable electrical power units from the total number of electrical power units in the technical unit and the initiation of the administrator user dialog for the purpose of accrediting identified electrical power units
the steps of the access to and the activation of the software applications and
the steps of the image capture and the image evaluation of graphical representations are periodically repeated without the step of the menu-driven and administrator-user-controlled identification of electrical power units and the step of the initiation of the administrator user dialog being carried out again beforehand.

Normally, the number and type of accreditable electrical power units changes less quickly than the status data thereof. In this respect, the status data should be updated at shorter intervals of time by the recurring ascertainment so that the control of energy flow for the technical unit for the purpose of optimizing own consumption and/or supporting the network registers changes in the status parameters in good time.

In future, it is also conceivable that the step of identifying electrical power units in the technical unit will take place in automated fashion by virtue of the computer program product evaluating an existing smart home system and/or analyzing the software applications, already installed on digital terminals of the administrator user, of electrical power units for their accreditability. In this way it would be particularly easily possible for the computer program product to gain an overview of accreditable electrical power units and to communicate the accreditation options to the administrator user of the technical unit.

Irrespective of whether the identification step takes place in menu-driven fashion and in a manner controlled by an administrator user or in automated fashion, the administrator user subsequently makes his selection of the electrical power units to be accredited. At the same time, the administrator user permits forwarding of his personal access data for the software applications to be accredited that belong to the electrical power units to be accredited. Said data are normally transmitted once via secure, encrypted data connections to the access data storage means of the computer program product and stored there. This process is explained in more detail in connection with the description of the methods depicted below for the control of energy flows that supports the network and/or optimizes own consumption using one of the previously described computer program products.

As already mentioned, the computer program product easily provides essential information in the form of the ascertained status data of accredited power units so that a method for providing electrical control power for a transmission network can be carried out by a technical unit as defined by the present invention for an electrical energy transmission network. A technical unit such as this is formed, according to the present definition, by the sum of electrical power units that are capturable by way of a common electrical meter unit.

This is routinely the case with buildings and building complexes of private households and commercial operations. Not all electrical power units in this case are accreditable as defined by the present invention. However, it suffices for some of the electrical power units, in particular those with a significant potential, in comparison with all of the electrical power units, for drawing and/or delivering positive and negative control power, to be accredited using the computer program product and for said electrical power units to be operated so as to support the network. The other, unaccreditable, electrical power units can likewise be used to provide control power, however. This is described later in connection with the detailed explanation of the associated method.

The accreditable electrical power units with significant control power potential are in particular electrical power units that are in the form of:
electrical energy stores with electrochemically active secondary cells, with electrically active capacitors, with conversion of electrical energy to thermal or mechanical energy to be stored, along with the possibility of conversion back to electrical energy,
refrigerators and freezers,
the batteries of vehicles with electric drives,
lawnmower robots,
domestic vacuum cleaner robots,
electrical heating and cooling devices, including air conditioning installations and storage heaters,
heat pumps of building heating systems,
electrical loads with a power draw of more than 500 watts,
mini- and nano-cogeneration units and
power generating installations such as PV installations, hydroelectric and wind power installations.

A prerequisite for carrying out a method for providing electrical control power by means of a technical unit for an electrical transmission network is therefore that the technical unit has a plurality of accreditable electrical power units with significant control power potential.

Alternatively or cumulatively, the method can additionally be performed to optimize the own consumption of a technical unit having a plurality of accreditable electrical power units, with a controllable electrical energy store, and an electrical power unit for generating electrical energy.

This method is characterized by the following method steps:
executing a computer program product according to one of the previously described embodiments that is installed such that status data of accredited power units of the technical unit are ascertained,
reading the status data, ascertained by the computer program product, of accredited electrical power units of the technical unit,
incorporating the read status data during the ascertainment and provision of electrical control power by switching and controlling accredited electrical power units in the technical unit and/or
incorporating the read status data for the purpose of controlling electrical energy flows by switching and controlling accredited electrical power units in the technical unit with the aim of optimizing the own consumption of the technical unit.

The status data ascertained by the computer program product comprise, as an image of the present status, the fill levels of electrical energy stores or of batteries for wirelessly operated devices and electric vehicles, and also performance parameters such as for example:
the ideal temperature to be reached for a freezer/refrigerator, including the acceptable deviations from this ideal temperature in the positive and negative directions;
the desired temperature characteristic to be produced for the next few days and weeks by a heating system or an air conditioning installation in a building, and
temporally recurring rules for the activation of electrical power units and/or causalities for the activation of an electrical power unit (washing machine) entailing the subsequent activation of another electrical power unit (tumble dryer) at least in winter or in unsuitable weather for conventional laundry drying in the open air.

By incorporating such status data, a control unit controls the electrical energy flows inside the technical unit. This control unit can have all or some of its functionality located inside the technical unit, or else all or some of its functionality located outside the technical unit, as an interacting combination of hardware and software.

There are multiple scenarios for the location of the computer program product, of which three different ones are described in more detail below.

In a preferred first variant of the method for optimizing own consumption and/or for controlling the accredited electrical power units so as to support the network, there is provision for the computer program product to be executed on a digital terminal, wherein the digital terminal has administrator rights for the software applications of the accredited power units of the technical unit. In this variant, fresh installation of the software applications of accredited power units is not required. These are already installed on the digital terminal of an administrator user of the technical unit. The computer program product is installed on the same digital terminal and is equipped, by the administrator user, with the rights and approvals, in particular the personal access data, for the computer program product to be able to start and evaluate the accredited software applications, as described above, in order to ascertain the status data of the accredited electrical power units. This digital terminal is normally a smartphone, a tablet or a desktop computer or a laptop of an administrator user of the technical unit.

In an alternative second, preferred variant, the method for optimizing own consumption and/or for controlling the accredited electrical power units so as to support the network is designed such that the computer program product is executed on an additional computer arranged inside the technical unit. This is a digital terminal that is provided inside the technical unit in addition to those described previously. Preferably, the additional computer is simultaneously used for controlling a controllable electrical energy store or for controlling a charging box for an electric vehicle inside the technical unit, for example. Normally, it is the computer installed in physical unity with or at least in physical proximity to the electrical energy store or the charging box for an electric vehicle. The software applications of the electrical power units to be accredited can be installed on the operating system of this additional computer. This installation can be approved and performed by the administrator user in parallel with the installation of the same software applications on a digital terminal of the administrator user. It is likewise conceivable for the administrator user to install the software application of one or more electrical power units to be accredited not on his digital terminal but rather only on the additional computer. Irrespective of whether parallel or sole installation on the additional computer is involved, it is necessary for the administrator user of the electrical power units of the technical unit to provide or approve the personal access data for accessing the accredited software applications. Various scenarios are conceivable for setup of the software applications to be accredited on the additional computer. First, the administrator can perform setup directly on the additional computer by operating said additional computer directly or by way of remote computer access. Direct input of the personal access data for the software applications to be accredited would be possible in this case. If said personal access data are not intended to be manually input again, they can also be transmitted from a digital terminal of the administrator user to the additional computer via a secure data connection. The personal access data are ultimately stored in access data storage means of the computer program product. They are protected there against unauthorized reading, as has already been described.

The preferred first and second variants for the method each afford the advantage that the personal access data are stored exclusively inside the technical unit. There, these data are protected both against external and internal spying by virtue of the measures taken by the administrator user himself and against unauthorized reading by virtue of protection that is inherent to the computer program product. This increases the confidence of administrator users in use of the computer program product.

In an alternative third preferred variant, the method for optimizing own consumption and/or for controlling the accredited electrical power units so as to support the network is designed such that the computer program product is executed on an external computer physically arranged outside the technical unit. This external computer can be a computer of a service provider performing optimization of own consumption and/or control of the electrical energy flows of the accredited electrical power units that supports the network with the consent of the administrator user. The personal access data are then stored externally to the technical unit and are robustly protected there against unauthorized reading. The one-off transmission required for the personal access data is carried out via a secure connection, for example using https protocols or VPN tunnels and/or by way of an encrypted transmission of the personal access data, for example by means of PGP or other tried and tested robust encryption methods.

Finally, the invention also relates to an electrical energy store, in particular in the form of secondary cells, for a building with a control computer for controlling electrical energy flows in the building, wherein a computer program product according to one of the previous described variants is installed on the computer. The electrical power units connected to the electrical supply network in the building are then the technical unit. This computer is functionally a part of the control units that perform or at least contribute to the performance of the previously described methods.

A few purely illustrative embodiments of the computer program product, the method for optimizing own consumption and/or for controlling the accredited electrical power units so as to support the network, and the electrical energy store for a building with a computer for controlling electrical energy flows in the building are explained in more detail in connection with the figures described below, in which:

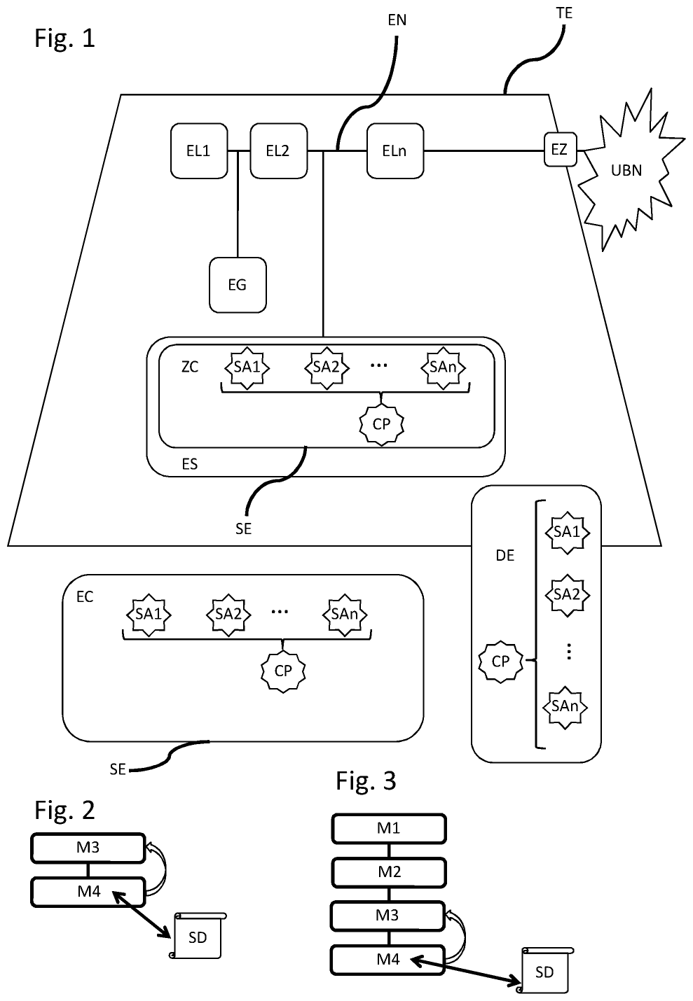

FIG. 1 shows a schematic overview of a technical unit with accredited electrical power units contained therein;

FIG. 2 shows a flowchart for the program steps of a first embodiment of the computer program product;

FIG. 3 shows a flowchart for the program steps of a second embodiment of the computer program product;

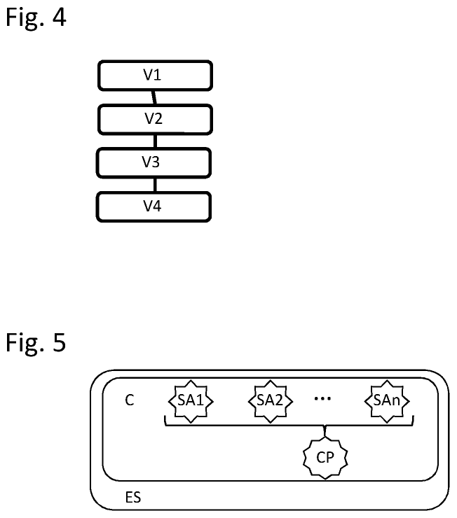

FIG. 4 shows the method steps of an embodiment of the method for optimizing own consumption and/or for controlling accredited electrical power units in a technical unit so as to support the network, and

FIG. 5 shows, purely schematically, an embodiment of an electrical energy store for a building, forming a technical unit, with a control computer C for controlling electrical energy flows.

FIG. 1 shows, purely by way of illustration, a schematic overview of a technical unit TE with accredited electrical power units EL1,EL2, . . . ELn contained therein. The electrical power units EL1,EL2, . . . ELn are connected to an electrical energy network EN inside the technical unit TE. Additionally, unaccreditable electrical power units such as for example an electrical power unit for generating electrical energy EG and an unaccredited electrical power unit in the form of an electrical energy store ES are also connected to the electrical energy network EN inside the technical unit TE. The electrical power units can draw and/or deliver electrical power depending on the technical design.

The electrical energy network EN is connected to an external transmission network UBN of an electrical transmission network operator via an electrical meter unit EZ. The total number of electrical power units whose energy flows are measurable from or to the transmission network via the electrical meter unit EZ ultimately defines the technical unit TE. The technical unit TE will routinely be in the form of a house or a building whose electrical power units EL1,EL2, . . . ELn,EG,ES situated therein are connected to the transmission network UBN via an electrical meter unit EZ referred to as the house or building meter.

The electrical energy store ES has an additional computer ZC designed in particular for controlling the energy flows from and to the electrical energy store ES.

Additionally, a digital terminal DE in the form of a smartphone or a tablet is shown. This digital terminal DE has administrator user rights for the accredited electrical power units EL1,EL2, . . . ELn. It can be physically situated either inside the technical unit TE or outside the technical unit TE. Since the digital terminal DE has administrator rights for the accredited electrical power units EL1,EL2, . . . ELn, software applications SA1,5A2, . . . SAn of the respective accredited electrical power units EL1,EL2, . . . ELn are installed on its operating system.

Provided that the additional computer ZC of the electrical power unit in the form of an electrical energy store ES affords a suitable operating system, the software applications SA1,5A2, . . . SAn of the accredited electrical power units EL1,EL2, . . . ELn can be installed there cumulatively or as an alternative to the digital terminal DE.

As a third variant, there can cumulatively or alternatively be provision for the software applications SA1,5A2, . . . SAn of the accredited electrical power units EL1,EL2 . . . ELn to be installed on an external computer EC that is physically and electrically situated outside the technical unit TE.

The device where the software applications SA1,5A2, . . . SAn of the accredited power units EL1,EL2, . . . ELn are installed additionally has a computer program product installed on it that interacts with the software applications SA1,SA2, . . . SAn as described below. In the present case, the software applications SA1,SA2, . . . SAn are installed both on the electrical energy store ES and on the digital terminal DE and the external computer EC. However, one of the three installation options is sufficient to realize the functionality described below.

An administrator user of the technical unit TE has conveyed the personal access data of the administrator user for the respective software applications SA1,SA2, . . . SAn of the accredited electrical power units EL1,EL2, . . . ELn, and has stored said personal access data in access data storage means of the computer program product CP, during installation of the computer program product CP. As a result, the computer program product CP is able, in an automated manner, to access the software applications SA1,SA2, . . . SAn of the accredited electrical power units EL1,EL2, . . . ELn, to activate said accredited electrical power units and to subsequently use image capture and image evaluation to ascertain status data of the accredited electrical power units EL1,EL2, . . . ELn.

FIG. 2 shows a flowchart for the program steps of a first embodiment of the computer program product during the ascertainment of status data SD of accredited electrical power units EL1,EL2, . . . ELn.

First, step M3 involves activating the software applications SA1,5A2, . . . SAn of accredited electrical power units EL1,EL2, . . . ELn by using the personal access data that are required for the automated access to the software applications SA1,5A2, . . . SAn by the computer program product CP and are held for this purpose in the access data storage means of the computer program product (CP). The subsequent program step M4 involves carrying out image capture and image evaluation of graphical representations that are available, having been generated by the software applications SA1,SA2, . . . SAn, during the automated access to the software applications SA1,5A2, . . . SAn of the accredited electrical power units EL1,EL2, . . . ELn, wherein the image evaluation is designed to ascertain status data SD of the accredited electrical power units EL1,EL2, . . . ELn and to store said status data in a status data memory and/or to transmit said status data to a control unit SE.

After a certain time, program step M3 is first repeated and is then followed by program step M4 again, as a result of which the status data SD are updated in this way.

FIG. 3 shows a flowchart for the program steps of a second embodiment of the computer program product CP. The second embodiment corresponds to program steps M3 and M4 of the first embodiment of the computer program product that is shown in FIG. 2, but with the two program steps M3 and M4, to which the explanations provided in relation to FIG. 2 apply, being chronologically preceded by further program steps M1 and M2.

Program step M1 first involves carrying out the menu-driven and administrator-user-controlled identification M1 of accreditable electrical power units EL1,EL2, . . . ELn inside the technical unit TE. This is aided by a database or a database access function that assigns associated software applications of electrical power units detected as accreditable.

This is followed by the initiation M2 of an administrator user dialog that an administrator user uses to select those of the electrical power units EL1,EL2, . . . ELn detected as accreditable that are supposed to be accredited by the computer program product CP, wherein the personal access data of the administrator user for the software applications SA1,5A2, . . . SAn of the electrical power units to be accredited are captured and stored.

Next, program steps M3 and M4 are executed, as described in relation to FIG. 2, in order to ascertain the status data SD of the accredited electrical power units EL1,EL2, . . . ELn, and steps M3 and M4 are repeated after a certain waiting time.

FIG. 4 shows the method steps of an embodiment of a method for optimizing own consumption and/or for controlling accredited electrical power units EL1,EL2, . . . ELn in a technical unit TE so as to support the network.

First, method step V1 involves executing a computer program product CP having the previously described features that is installed such that status data SD of accredited power units EL1,EL2, . . . ELn of the technical unit TE are ascertained. Next, method step V2 involves reading the status data SD, ascertained by the computer program product CP, of accredited electrical power units EL1,EL2, . . . ELn of the technical unit TE. The read status data SD are then incorporated in method step V3 during the ascertainment and provision of electrical control power by switching and controlling accredited electrical power units EL1,EL2, . . . ELn in the technical unit TE. Alternatively or cumulatively, method step V4 involves incorporating read status data SD for the purpose of controlling electrical energy flows by switching and controlling accredited electrical power units EL1,EL2, . . . ELn in the technical unit TE with the aim of optimizing the own consumption of the technical unit.

FIG. 5 shows, purely schematically, an embodiment of an electrical energy store ES for a building, forming a technical unit TE, with a control computer C for controlling electrical energy flows inside the technical unit TE of the building and between the technical unit TE and a connected transmission network UBN.

### LIST OF REFERENCE SIGNS

TE technical unit
EN electrical energy network of the technical unit
EL1 ,EL2, . . . ELn electrical power units
SA1,SA2, . . . SAn software applications assigned to each of the electrical power units
CP computer program product
SD status data of accredited electrical power units
SE control unit
DE digital terminal
UBN electrical transmission network
EZ electrical meter unit
ES controllable electrical energy store
EG electrical power unit for generating electrical energy
ZC additional computer
EC external computer
C control computer
M1 computer program product program step: identification of accreditable electrical power units inside the technical unit
M2 computer program product program step: initiation of an administrator user dialog
M3 computer program product program steps: access to and activation of software applications of accredited electrical power units
M4 computer program product program steps: image capture and image evaluation of graphical representations of the software applications
V1 method step of executing a computer program product according to the invention;
V2 method step of reading the status data ascertained by the computer program product,
V3 method step of incorporating the read status data during the ascertainment and provision of electrical control power
V4 method step of incorporating the read status data to optimize the own consumption of the technical unit.

1. A computer program product (CP) for reading status data of a plurality of electrical power units (EL1,EL2, . . . ELn) connected to an electrical energy network (EN) in a technical unit (TE), wherein each of these electrical power units (EL1,EL2, . . . ELn) has an assigned software application (SA1,SA2, . . . SAn) and the software applications of these electrical power units are installed or installable on a digital terminal (DE) or on a plurality of digital terminals, wherein the computer program product (CP) has software means that, when executed on a computer, cause the computer to perform the following steps:
access to and activation (M3) of software applications (SA1,SA2, . . . SAn) of accredited electrical power units (EL1,EL2, . . . ELn) by using personal access data that are required for automated access to the software applications (SA1,SA2, . . . SAn) of accredited electrical power units by the computer program product (CP) and are held for this purpose in access data storage means of the computer program product (CP), and
image capture and image evaluation (M4) of graphical representations that are available, having been generated by the software applications, during the automated access to the software applications (SA1,SA2, . . . SAn) of the accredited electrical power units (EL1,EL2, . . . ELn), wherein the image evaluation is designed to ascertain status data (SD) of the accredited electrical power units and to store said status data in a status data memory and/or to transmit said status data to a control unit (SE).

2. The computer program product (CP) as claimed in claim 1, characterized in that during the access to and during the activation (M3) of accredited electrical power units (EL1,EL2, . . . ELn) a database of the computer program product or a database access function provides information that simplifies localization and/or the image evaluation of relevant areas in the graphical representations of the software applications of accredited power units for the purpose of ascertaining the status data (SD).

3. The computer program product (CP) as claimed in claim 1, wherein the ascertained status data (SD) are converted into a standard numerical code and stored.

4. The computer program product (CP) as claimed in claim 1, wherein the access data storage means are designed to be protected against being read by networked devices that are situated outside the network domain in which the computer program product (CP) is installed.

5. The computer program product (CP) as claimed in claim 1, wherein the access data storage means are designed to be protected against being read by networked devices with a different IP address than the IP address of the computer on which the computer program product (CP) is installed.

6. The computer program product (CP) as claimed in claim 1, wherein the ascertained status data (SD) also comprise performance parameters of the accredited electrical power units (EL1,EL2, . . . ELn).

7. The computer program product (CP) as claimed in claim 1, wherein before the access to and the activation and before the image capture and the image evaluation, the computer code is executed by the computer to:
provide a menu-driven and administrator-user-controlled identification (M1) of accreditable electrical power units (EL1,EL2, . . . ELn) inside the technical unit (TE) by means of a database or by means of a database access function that identifies associated software applications of the accreditable electrical power units, and
initiate (M2) of an administrator user dialog that an administrator user uses to select those of the electrical power units detected as accreditable that are supposed to be accredited by the computer program product (CP), wherein the personal access data of the administrator user for the software applications of the electrical power units to be accredited are captured and stored.

8. The computer program product (CP) as claimed in claim 7 wherein during the capture of the personal access data of the administrator user said administrator user is provided with a selection option for his personal access data to be stored exclusively in the computer program product, which is installed on a computer that is integrated inside the technical unit or is in the form of a digital terminal of the administrator user, wherein the computer is set up such that external access for the purpose of reading these personal access data from the computer program product is blocked without exception.

9. The computer program product (CP) as claimed in claim 7, wherein after the steps of the menu-driven and administrator-user-controlled identification (M1) of accreditable electrical power units from the total number of electrical power units in the technical unit and the initiation (M2) of the administrator user dialog for the purpose of accrediting identified electrical power units
the steps of the access to and the activation (M3) of the software applications and
the steps of the image capture and the image evaluation (M4) of graphical representations are periodically repeated without the step of the menu-driven and administrator-user-controlled identification (M1) of electrical power units and the step of the initiation (M2) of the administrator user dialog being carried out again beforehand.

10. The computer program product (CP) as claimed in claim 7, wherein the identification (M1) of the electrical power units for the purposes of a search function accesses the one digital terminal (DE) or the plurality of digital terminals and evaluates the software applications installed on the digital terminal(s) (DE) and/or uses access to a smart home program on a digital terminal to ascertain accreditable power units.

11. A method for providing electrical control power by means of a technical unit (TE) for an electrical transmission network (UBN), the technical unit (TE) having a plurality of accreditable electrical power units, and/or a method for optimizing the own consumption of a technical unit (TE) having a plurality of accreditable electrical power units with a controllable electrical energy store (ES) and an electrical power unit for generating electrical energy (EZ), wherein the method comprises:
executing (V1) a computer program product (CP) as claimed in claim 1 that is installed such that status data (SD) of accredited power units (EL1,EL2, . . . ELn) of the technical unit (TE) are ascertained,
reading (V2) the status data (SD), ascertained by the computer program product (CP), of accredited electrical power units (EL1,EL2, . . . ELn) of the technical unit (TE),
incorporating (V3) the read status data (SD) during the ascertainment and provision of electrical control power by switching and controlling accredited electrical power units (EL1,EL2, . . . ELn) in the technical unit (TE) and/or
incorporating (V4) the read status data (SD) for the purpose of controlling electrical energy flows by switching and controlling accredited electrical power units (EL1,EL2, . . . ELn) in the technical unit (TE) with the aim of optimizing the own consumption of the technical unit.

12. The method as claimed in claim 11, wherein the method is executed on a digital terminal (DE), wherein the digital terminal (DE) has administrator rights for the software applications of the accredited power units (EL1,EL2, . . . ELn) of the technical unit (TE).

13. The method as claimed in claim 11, wherein the method is executed on an additional computer (ZC) arranged inside the technical unit.

14. The method as claimed in claim 13, wherein the additional computer (ZC) is simultaneously used to control the controllable electrical energy store (ES) of the technical unit (TE).

15. The method as claimed in claim 11, wherein the method is executed on an external computer (EC) physically arranged outside the technical unit (TE).

16. An electrical energy store for a building with a control computer (C) for controlling electrical energy flows in the building, wherein a computer program product (CP) as claimed in claim 1 is installed on the control computer (C).
